(19) United States
(12) Patent Application Publication
(10) Pub. No.: US 2025/0174930 A1
(43) Pub. Date: May 29, 2025

(54) GROUNDING MODULE WHICH IS TO BE RECEIVED IN A METAL PLUG CONNECTOR MODULAR FRAME AND WHICH GROUNDS SAME

(71) Applicant: HARTING Electric Stiftung & Co. KG, Espelkamp (DE)

(72) Inventor: Luca BALTRUSCHAT, Minden (DE)

(21) Appl. No.: 18/840,006

(22) PCT Filed: Mar. 13, 2023
(86) PCT No.: PCT/DE2023/100185

§ 371 Date: Aug. 20, 2024

(30) Foreign Application Priority Data
Mar. 28, 2022 (DE) 10 2022 107 244.4

(51) Int. Cl. H01R 13/518; H01R 4/48; H01R 4/64; H01R 11/09; H01R 13/514

(52) U.S. Cl. CPC H01R 13/518; H01R 4/4821; H01R 4/64; H01R 11/09; H01R 13/514

(57) ABSTRACT

A grounding module with a single-part grounding element is provided in order to ground a plug connector modular frame. The grounding element can be made of a resilient elastic sheet metal in the form of a stamped bent part. The single-part grounding element forms a contact spring with a contact arm for electrically contacting the plug connector modular frame as well as a busbar and a V-shaped clamping spring for connecting a grounding line to the busbar in an electric manner and so as to produce a mechanical fixation.

The invention starts from a grounding module in accordance with the preamble of independent claim 1.

In addition, the invention starts from a plug connector modular system having at least the grounding module as claimed in claim 1 and a plug connector modular frame.

The grounding module is a plug connector module, the intended function of which is the electrical grounding of a metal plug connector modular frame. Grounding modules of this kind are thus required in order to electrically ground metal plug connector modular frames or, if the plug connector modular frame already has a ground terminal, to additionally increase the grounding cross section of any already existing electrical grounding connection.

The grounding module is thus a plug connector module which is configured to connect a grounding line in an electrically conductive manner to the metal plug connector modular frame. The grounding line, also referred to as a “PG” (Protective Ground) line, can be, for example, a grounding line of an electrical cable, e.g. of a grounding cable or, alternatively, of a cable which has a plurality of current-carrying cores and additionally said grounding line. The grounding line, often also referred to as a grounding core, has at least one electrical conductor, e.g. a wire, e.g. a copper wire, preferably a multiplicity of wires, in particular copper wires, which can jointly form a flexible stranded conductor.

To form a plug connector, in particular a heavy-duty plug connector, the plug connector modular frame can be built into a metal plug connector housing, and this plug connector housing can thereby provide grounding, in particular via said grounding line, with a particularly large conductor cross section. In particular, the grounding module can additionally have a plug-in contact for grounding transmission to a mating plug, which is plugged together with the plug connector, in particular said heavy-duty plug connector. A heavy-duty plug connector is used, for example, in industrial installations and is usually designed to transmit particularly high currents of, for example, at least 10 A (amperes), in particular at least 16 A, that is to say, for example, at least 32 A, that is to say, for example, 64 A and above. On account of these high currents, it must also be possible to discharge a high fault current in the event of a fault, i.e. grounding high-current plug connectors generally requires a large conductor cross section, which can be in the range of 80 mm² to 90 mm² or even 90 mm² to 100 mm² and above, for example, in the case of very high permitted currents of, for example, even more than 90 A. If the plug connector is a heavy-duty plug connector, the mating plug is generally likewise embodied as a heavy-duty plug connector.

Plug connector modules are generally required as part of a plug connector modular system to enable a plug connector, in particular a heavy-duty plug connector, to be adapted flexibly to particular requirements in respect of signal and power transmission, e.g. between two electrical devices. The functioning of a plug connector formed in this way is therefore very flexible. For example, pneumatic modules, optical modules, modules for transmitting electrical energy and/or electrical analog and/or digital signals can be accommodated in the plug connector modular frame and thus used in the plug connector modular system. Plug connector modules are also increasingly taking over metrological and data-related tasks.

It is thereby possible to transmit a very wide variety of, for example, optical and/or electrical analog and/or digital signals and/or electrical energy via a plug connection in a manner that allows flexible combination according to requirements. The transmission of electrical energy on the abovementioned scale is of course particularly important in the heavy-duty plug connector sector in industrial environments.

For this purpose, the corresponding plug connector modules are usually inserted into said plug connector modular frames, which are sometimes also referred to as holding frames, articulated frames, module frames or modular frames and, in some cases, also as receiving frames. The plug connector modular frames thus serve to receive a plurality of plug connector modules which are of the same type and/or, alternatively, different and to fix them securely on a surface and/or a device wall and/or in a plug connector housing or the like. As already mentioned, the plug connector modular frames, insofar as they consist at least partially of metal, can additionally serve to be installed in metal plug connector housings and thereby also to ground said metal plug connector housings in order to form a heavy-duty plug connector.

The plug connector modules generally each have a substantially cuboidal housing, which is sometimes also referred to as an insulator. These insulators may consist of plastic and may be embodied either as one-piece or multi-piece, e.g. two-piece, insulators and, for example, may consist of a contact support and a top-mounted part, which can be secured thereon and, in particular, can be latched thereon, e.g. a cover plate and, in particular, a holding plate. By means of such a holding plate, the plug connector modules can receive plug-in contacts, for example, in their contact chambers and fix them therein.

To hold a plurality of these plug connector modules in the plug connector housing, said plug connector modular frames are generally used, as already mentioned. Many different designs are known for plug connector modular frames.

The plug connector modular frames can be formed from two frame halves that can be pivoted relative to one another, being connected to one another in an articulated manner. The plug connector modules can be provided with fixing means projecting from the narrow sides, in particular in the form of projections, e.g. especially rectangular latching projections as retention and polarization means for their fixing and correct alignment in the plug connector modular frame. For polarization, it is possible in particular, for the two projections, in particular the two latching projections, of a plug connector module to differ in shape, in particular in width, in order to prevent insertion of the plug connector modules in an incorrect orientation in the plug connector modular frame.

Recesses, in particular recesses designed as openings closed all round, e.g. “windows”, in particular “latching windows”, can be provided in the side parts of the frame halves, into which recesses the latching projections enter when the plug connector modules are inserted into the holding frame. To insert the plug connector modules, the abovementioned articulated frame is “swung open”, i.e. opened, with the frame halves being pivoted away from one another around the joints only to an extent sufficient for the plug connector modules to be inserted. The frame halves are then swung together, i.e. the plug connector modular frame is closed, wherein the side parts are aligned in parallel and the retention means enter the recesses, and secure, positive retention of the plug connector modules in the plug connector modular frame is thus effected.

However, the designs of plug connector modular frames are multifarious. As a departure from the abovementioned design, it is also possible, for example, to use plug connector modular frames that each have a rigid base frame. It is possible, in particular, for this to be produced in a diecasting process, e.g. in the zinc diecasting process, and it can be provided on its longitudinal sides with a plurality of flexible cheek parts, e.g. stamped and bent parts, on the inside or outside of the frame. In this case, the cheek parts can have latching means, such as said latching windows or, alternatively, latching hooks or the like. The plug connector modules can latch onto these latching means by means of their latching projections, for example. It is possible, for example, for two cheek parts to be provided for each plug connector module, that is to say one on each longitudinal side of the base frame, or, alternatively, to use one or more cheek parts having a plurality of tabs. It is possible, for example, for one latching element to be arranged on each cheek part or each tab. Such plug connector modular frames, which are produced in a composite construction, have the advantage that the plug connector modules can be inserted individually into the plug connector modular frames and removed from them with only a little effort and, for example, also in an automated manner. In addition, the prior art also discloses designs for metal plug connector modular frames which are formed for low-cost production and exclusively from sheet metal.

### PRIOR ART

In the prior art, said plug connector modular systems with plug connector modules of this kind using such a plug connector modular frame, also known as a holding frame, module frame, articulated frame or module frame, have been disclosed in numerous documents and publications in many different variants, have been shown at trade fairs, and are in frequent use in industrial environments in the form of heavy-duty plug connectors. They are described in DE 10 2013 106 279 A1, DE 10 2012 110 907 A1, DE 10 2012 107 270 A1, DE 20 2013 103 611 U1, EP 2 510 590 A1, EP 2 510 589 A1, DE 20 2011 050 643 U1, EP 0 860 906 A2, DE 29 601 998 U1, EP 1 353 412 A2, DE 10 2015 104 562 A1, EP 3 067 993 A1, EP 1 026 788 A1, EP 2 979 326 A1 and EP 2 917 974 A1, for example.

Said document EP 0 860 906 B1 discloses a plug connector modular frame in the form of an articulated frame for holding plug connector modules and for installation in plug connector housings or for screwing to wall surfaces. In this case, the plug connector modules are inserted into the plug connector modular frame. Retention means, which interact with windows provided in opposite side parts of the plug connector modular frame, are provided on the plug connector modules, wherein the windows consist in rectangular recesses which are designed as through openings closed all round in the side parts of the plug connector modular frame.

In the embodiment as an articulated frame, the plug connector modular frame consists of two frame halves connected to one another in an articulated manner, wherein the division of the plug connector modular frame is provided transversely to the side parts of the frame. Joints are arranged in the fastening ends of the plug connector modular frame in such a way that, when the plug connector modular frame is screwed onto a fastening surface, the side parts are aligned at right angles to the fastening surface, whereby the plug connector modules enter into a positive connection with the plug connector modular frame via the retention means. In practice, such plug connector modular frames are usually manufactured in a diecasting process, in particular in a zinc diecasting process.

DE 10 2015 114 703 A1 discloses a further developments of such a plug connector modular frame designed as an articulated frame. The plug connector modular frame disclosed therein has at least one fixing means, by means of which the frame halves can be fixed relative to one another in two positions, an open position and a closed position, considerably simplifying handling.

DE 20 2013 103 611 U1 shows two frame halves, suitable for receiving pneumatic modules inter alia, which can be screwed to one another in an extremely stable manner, can be produced cheaply by stamping and bending and can be screwed together. The plug connector modular frame assembled in this way exhibits only very slight creep properties, even under high mechanical long-term loading. However, the disadvantage is that the effort involved in adding or exchanging a plug connector module is extremely high.

To improve convenience of operation, DE 10 2013 113 975 B4 discloses a plug connector modular frame, in particular a frame made of diecast zinc, for a heavy plug connector for receiving plug connector modules that are of the same type and/or different. The plug connector modular frame consists of a base frame of rectangular cross section which has two mutually opposite side parts. A cheek part consisting of a flexible material, in particular spring-elastic sheet metal, is attached to each of the side parts. As a plug connector module is inserted into the plug connector modular frame perpendicularly to the plane of the frame, these cheek parts are initially bent outward by the side part. In particular, the cheek parts can have tabs with latching windows, which are suitable for latching the plug connector modules individually at their latching projections in the plug connector modular frame. The plug connector modules can thus be inserted into the plug connector modular frame from the cable connection direction and in the plug-in direction and removed again in the opposite direction individually and with only a little effort. The inserted plug connector module is held firmly and in a stable manner in the plane of the frame by the base frame of the plug connector modular frame. In their insertion direction, perpendicular to the plane of the frame, they can each be latched by means of their latching projections between mutually opposite cheek parts. This design fundamentally has the advantage that the plug connector modules can be inserted and removed again individually without the fastening of the other plug connector modules being impaired thereby. The design furthermore makes it possible for the plug connector modular frame to consist of metal and to have a PG contact or to be equipped with such a contact, and thus allows said protective grounding and optionally, in addition, electrical shield connection of shielded plug connector modules.

The problem that the grounding of the plug connector modular frame is not always adequate is known in principle in the prior art. On account of the design, it may be that the metal plug connector modular frames do not have their own grounding contact at all, e.g. if they consist of sheet metal. Diecast zinc frames generally have a PG screw contact as a grounding contact. However, this generally allows only limited conductor cross sections of the grounding line to be screwed thereto, with these conductor cross sections being too small for many applications, especially high-current applications. On the other hand, plug connector modular systems are used predominantly in industrial environments and must accordingly be capable of being able to safely transmit the high currents mentioned at the outset and, in addition, should also allow connection to grounding lines with the grounding cross sections mentioned at the outset.

For this reason, DE 10 2013 108 383 A1 proposes an electrical plug connector module which is embodied as a grounding module. This is suitable, either alone or in combination with other plug connector modules, for the formation of a modular plug connector. In this case, depending on the embodiment, the electrical plug connector module can be inserted directly into a plug connector housing or received in a holding frame (i.e. plug connector modular frame) and secured in a plug connector housing together with the other plug connector modules. In this case, the grounding module has an electrical contact means which is connected in an electrically conductive manner in the interior of the electrical plug connector module to an electrical contact received therein. Said electrical contact means routed to the outside of the electrical plug connector module furthermore establishes contact, via a spring region, with the holding frame or the plug connector housing into which the electrical plug connector module is inserted.

Building on this, DE 10 2020 119 128 A1 discloses a plug connector module for the convenient connection of a protective line. This comprises a housing, which can be inserted in an electrically contacting manner into a receiving frame to create a plug connector subassembly, a plug-in portion, arranged on the housing, for plug connection to an associated mating plug connector, and an electrical contact element, arranged on the plug-in portion, for establishing electrical contact with the mating plug connector. To establish electrical contact with the contact element, the protective line can be connected to a connection subassembly, which has a spring element comprising a clamping leg. The clamping leg is designed to act on the protective line in a clamping position for electrical contacting and mechanical retention. For establishing electrical contact with the receiving frame, the disclosure states that the housing as a whole is manufactured from an electrically conductive material, in particular a metal material, e.g. a zinc diecasting material, with the result that, when inserted into the receiving frame, the plug connector module comes into contact by means of its housing with the receiving frame and thereby establishes electrical contact with the receiving frame. If the plug connector module is inserted into the receiving frame and if a protective line is connected to the plug connector module, the receiving frame thus comes to the potential of the protective line.

One disadvantage in the prior art consists in the high outlay on materials and production that is required to produce a grounding module with such a high convenience of operation.

### PROBLEM

The problem to be solved by the invention consists in specifying a grounding module for metal plug connector modular frames which can be produced with as little effort as possible and nevertheless makes it possible to connect a grounding line, in particular a grounding line of an electrical cable, in particular of a grounding cable, thereto with only a little effort and thus to connect it in an electrically conductive manner to the plug connector modular frame. In particular, it should be possible to release the grounding line again from the grounding module conveniently when required.

The problem is solved by the subject matter of the independent claims.

A grounding module is provided to be received in a metal plug connector modular frame and serves to ground same by electrically conductive connection of the plug connector modular frame to a grounding line, in particular a grounding line of an electrical cable.

The grounding module has the following:
a housing, which has one or more fixing means for fixing the grounding module in the plug connector modular frame; and
a busbar, arranged in the housing, for the mechanical and electrical contacting of said grounding line;
a clamping spring arranged at least partially in the housing and having a clamping leg for pressing and clamping the grounding line inserted or to be inserted against the busbar; and
a contact spring, which, on the one hand, is connected in an electrically conductive manner to the busbar and, on the other hand, is passed out of the housing to an outer side of the housing in order to contact the metal plug connector modular frame in an electrically conductive manner,
   wherein
   both the busbar and the clamping spring and the contact spring are jointly part of a single, one-piece component, namely a grounding element.

A plug connector modular system has a plug connector modular frame and a grounding module of the abovementioned type. In particular, the plug connector modular system has one or more additional plug connector modules, which are received or at least can be received in the plug connector modular frame. These additional plug connector modules can be identical to or different from one another and can thus also perform identical or different functions. For example, pneumatic modules, optical modules, modules for transmitting electrical energy and/or electrical analog and/or digital signals can be used in this way in the plug connector modular system.

The plug connector modular frame is of substantially rectangular design in cross section and thus has two end faces situated opposite and parallel to one another and, at right angles thereto, two side parts situated opposite and parallel to one another. A flange is formed integrally on the end faces, in each case projecting at right angles thereto, wherein each of these two flanges has two through openings, in particular cylindrical through openings, as screw openings, in particular as screw holes, with the result that the plug connector modular frame has a total of four screw openings, in particular screw holes. At these screw openings, the plug connector modular frame can be screwed by means of its flange into or onto a metal plug connector housing, e.g. into a metal plug connector housing. This serves, on the one hand, for fastening and, on the other hand, for establishing electrical contact between the plug connector modular frame and the plug connector housing. In this case, the grounding module is received in the plug connector modular frame and, on the one hand, establishes contact with this plug connector modular frame by means of its contact spring. On the other hand, the grounding module is configured to press the grounding line, in particular the grounding line of the electrical cable, in particular of the grounding cable, against the busbar by means of its clamping spring and thus connect it in an electrically conductive manner to the latter. As a result, the grounding module is capable of producing an electrically conductive connection between the grounding line and the plug connector modular frame.

Advantageous embodiments of the invention are specified in the dependent claims and in the following description.

One advantage consists in the particularly high convenience of operation, which is provided by the fact that, in most applications, the grounding conductor has merely to be inserted between the busbar and the clamping leg in the “push-in” method in order to be connected to the plug connector modular frame, i.e. to be connected to the latter in an electrically conductive manner. This connection procedure can be carried out very easily by hand since the grounding module/the plug connector modular frame fitted with the grounding module can be held in one hand and the grounding line can be inserted into the grounding module with the other hand.

Another particular advantage of the invention consists in that the grounding module can be produced at low cost with very little effort. For example, its housing can consist at least partially, in particular at least very largely, preferably even completely, of plastic and, in particular, can be produced by injection molding. Furthermore, the housing can be produced in two parts and can also consist of a plug-side base housing and a top-mounted part on the cable connection side, which can be fastened on said housing/latched to said housing.

In a preferred embodiment, said one-piece grounding element can consist of metal and, in particular, of spring-elastic sheet metal. Said grounding element can preferably be a stamped and bent part.

As a result, both the busbar and the clamping spring and the contact spring can be produced at an extremely advantageous price from a single sheet by a stamping and bending process. For this purpose, an elongate shape, e.g. an elongate, e.g. rectangular, basic shape, can preferably be stamped out. As an alternative to the rectangular basic shape, it is also possible—depending on the design of the grounding module—for various portions of the grounding element to be embodied with different widths.

The grounding element can have a length along a longitudinal axis which is significantly greater than its width at its widest point. For example, the length of the grounding element can be at least three times, in particular at least five times, in particular at least eight times, preferably at least ten times and particularly preferably at least twelve times, as great as its aforementioned width.

In a preferred embodiment, the grounding element can be bent, in particular perpendicularly to its longitudinal axis, at several points, i.e. several times, in particular at right angles.

Furthermore, the grounding element can be inserted into the housing and secured in the housing, being latched in for example. The housing can then be closed, e.g. by means of said latching of the top-mounted part onto the base housing. As an alternative or in addition, the grounding element can also be overmolded with plastic to form the housing.

As a result, the invention has the advantage, in particular, of suitability for production that can be carried out in a particularly simple and easily automated way, and the further advantage of a large saving of materials because only those parts which are absolutely necessary for reliable electrically conductive connection and, where applicable, power transmission have to be made of metal. Moreover, the contact spring, busbar and clamping spring are produced from a simple stamped and bent part by means of just a few bends. In addition, the busbar is in one piece and, as a result, is connected electrically to the spring contact without electrical contact resistances. Moreover, not only the busbar but also the clamping leg makes electrical contact with the grounding conductor and thus contributes to the conductivity of the overall arrangement, which is already very good in any case.

As an alternative to the production of the housing from plastic, it is also possible for the housing of the grounding module to consist at least partially, in particular at least very largely, preferably even completely, of metal and, for example, to be produced in a zinc diecasting process. The grounding connection to the plug connector modular frame is then particularly large and consists both in a contact region of the contact spring and, additionally, in the points of contact between the housing of the grounding module and the plug connector modular frame. For example, electrical contact can be made between the plug connector module and the metal plug connector modular frame at the latching projections of a metal housing of the grounding module as an alternative or in addition to the electrical contacting of the plug connector modular frame by means of the contact spring. In another preferred embodiment, the contact spring can thus also be omitted. Moreover, the metal housing can be mechanically particularly robust and heat-resistant. In the case of this variant of a metal housing, however, the outlay on production and materials is also higher, and therefore this embodiment of a metal housing of the grounding module may be mentioned here merely as a possible, but not a preferred, alternative.

The invention has the particular advantage that, by virtue of said “push-in” contacting by means of the busbar and the clamping leg, even grounding lines with particularly large conductor cross sections can be connected to the grounding module and thus to the plug connector modular frame. By virtue of this design, it is possible, in more general terms, to connect various grounding lines with very different line cross sections, i.e. both with very small and very large conductor cross sections, to the grounding element.

It is furthermore of particular advantage that the electrical connection between the grounding line and the plug connector module frame in the form of said grounding element is formed in one piece from a single metal part. As a result, there are namely no contact resistances or mechanically releasable connections that would otherwise usually exist between a number of different component parts. Particularly in the case of high currents and/or temperatures, these could otherwise produce a particularly high electrical resistance. By virtue of the one-piece construction of the grounding element, the abovementioned arrangement is thus also particularly reliable and, in addition, inexpensive because the corresponding fastening and/or contacting devices are eliminated, and production is considerably simplified.

Said plug connector modular system can be installed, for example, in a metal plug connector housing and form a plug connector together with this plug connector housing. This plug connector can be plugged together with a mating plug, which, for example, may likewise have a comparable additional, in particular complementary, plug connector modular system.

As already mentioned, the housing of the grounding module can have a cuboidal basic shape, in particular with six outer sides.

The outer sides consist in two narrow sides, which run parallel to one another, and two broad sides, which run at right angles to the narrow sides and connect the narrow sides to one another. In addition, a cable connection side and a plug-in side can be provided as outer sides, wherein the cable connection side and the plug-in side are arranged opposite one another and at right angles to the narrow sides and the broad sides.

As a result, the housing of the grounding module can also correspond substantially to the shape of the further plug connector modules and can thus be integrated very easily into the plug connector modular system. Ultimately, the grounding module is a plug connector module.

In a preferred embodiment, said one or more fixing means are two latching projections, each of which is formed integrally on one of the two mutually opposite narrow sides of the housing.

These latching projections can be received in recesses, e.g. in windows, in particular latching windows, of the plug connector modular frame in order to fasten the grounding module, or can latch or be held in some other way on the plug connector modular frame.

Alternatively or in addition, the plug connector modular frame can have webs, in particular on an edge of its two side parts which is on the cable connection side, which webs extend counter to the insertion direction of the plug connector modules, in particular of the grounding module, and between which open recesses are formed. The latching projections of the respective plug connector module/grounding module can then be received in these recesses. Furthermore, the plug connector module/grounding module can be fixed in the plug connector modular frame by means of fastening means of the plug connector modular frame, e.g. on recesses in the plug connector modular frame, e.g., on the one hand, by the latching projections received in the recesses striking against a stop edge of the respective side part and, on the other hand, by an at least one latching means of the plug connector modular frame latching in the abovementioned position, e.g. by means of a latching window in a cheek part and/or by means of one or more latching hooks, wherein the latching hooks can be embodied separately and/or can be a part of one or more cheek parts. By means of the latching, they can be hindered in a movement in the direction of their cable connection side. In the opposite direction, i.e. towards their plug-in side, the latching projections can, as already mentioned, strike against the edge on the cable connection side. Perpendicularly thereto, the latching projections are held by the webs, and the housings of the plug connector modules/of the grounding module are held by the side parts.

The two latching projections of the grounding module may differ from one another in size and/or shape in order to ensure the correct polarization of the grounding module in the plug connector modular frame.

Accordingly, depending on the design, the windows and/or said recesses between the webs on the two mutually opposite side parts of the plug connector modular frame may be of different sizes. This makes it possible to ensure the correct orientation of the plug connector modules and of the grounding module in the plug connector modular frame.

In another preferred embodiment, the contact spring of the grounding module can extend along one of the two broad sides of the housing of the grounding module, coming from the direction of the cable connection side and running substantially in an S shape in the direction of the plug-in side. As a result of its S shape, the distance between the contact spring and the abovementioned broad side of the housing varies. This serves to connect the plug connector modular frame, into which the grounding module is inserted, to the contact spring in an electrically conductive manner on the outside.

In a preferred embodiment, the housing of the grounding module has, on its cable connection side, e.g. in the top-mounted part, a cable insertion opening for the insertion of the grounding cable.

Next to or on the cable insertion opening, the housing can have, on the cable connection side, in particular in the top-mounted part, an actuation opening for the insertion of a tool, e.g. a screwdriver, for separating the clamping leg from the grounding line, in particular from the grounding line of the grounding cable, and thus for releasing the grounding line from the busbar.

Thus, the grounding element can be arranged partially inside and partially outside the housing. In particular, the contact spring of the grounding element, which spring is preferably substantially S-shaped, can be arranged outside the housing. When the plug connector module is received in the plug connector modular frame, this contact spring can make contact with the plug connector modular frame, in particular from the outside.

In the further course of the grounding element, this contact spring may be adjoined by a central portion which is bent away, in particular by 180°, from the contact spring and forms the busbar of the grounding element. This busbar may be adjoined by a connecting portion which is bent away, in particular by 90° therefrom, and which can preferably have at least one through opening as a fastening opening. A plug-in contact can be attached, e.g. riveted or screwed, to this fastening opening, and thereby connected in an electrically conductive manner to the grounding element.

If the geometry of the grounding module requires it, e.g. if the plug-in contact is arranged offset with respect to the busbar, this connecting portion may also be wider than other portions, e.g. wider than the busbar. Alternatively, a geometrical compensation with respect to the position of the plug-in contact may also be brought about by the grounding element having a further electrically conductive connecting part which, for its part, has two further fastening openings, namely a first further fastening opening and a second further fastening opening. The first further fastening opening can be screwed or riveted to the fastening opening in the connecting portion, or fastened to it in some other way. The plug-in contact can be attached to the second, additional, fastening opening and thus connected in an electrically conductive manner to the grounding element. In each of the two abovementioned cases, said through opening in the connecting portion is provided as said fastening opening for the plug-in contact.

The plug-in contact is used for grounding transmission to a mating plug connector, in particular a further grounding module of the mating plug connector. Finally, a V-shaped clamping spring can be connected to the connecting portion. This has a retention leg, which is bent away from the connecting portion, in particular by 90°, in the initial position and thus preferably runs parallel to the busbar and from which the clamping leg is bent away at an acute angle, said clamping leg thus running obliquely toward the busbar and the connecting portion. By means of its free end, the clamping leg is capable of pressing the grounding line, in particular the grounding line of the electrical cable, against the busbar by elastic deformation of the V-shaped clamping spring, and both of connecting the grounding line in an electrically conductive manner to the busbar and of jamming/clamping it against being pulled out accidentally counter to its insertion direction.

The grounding module can thus have the plug-in contact, which is connected in an electrically conductive manner to the busbar and serves for grounding transmission, e.g. to a complementary plug-in contact of a further grounding module of said mating plug.

In a particularly preferred embodiment, the plug connector modular system can have a plurality of grounding modules, e.g. two grounding modules, in order to additionally increase the grounding cross section even further when required.

### EXEMPLARY EMBODIMENT

An exemplary embodiment of the invention is illustrated in the drawings and is described below in greater detail. In the drawings:

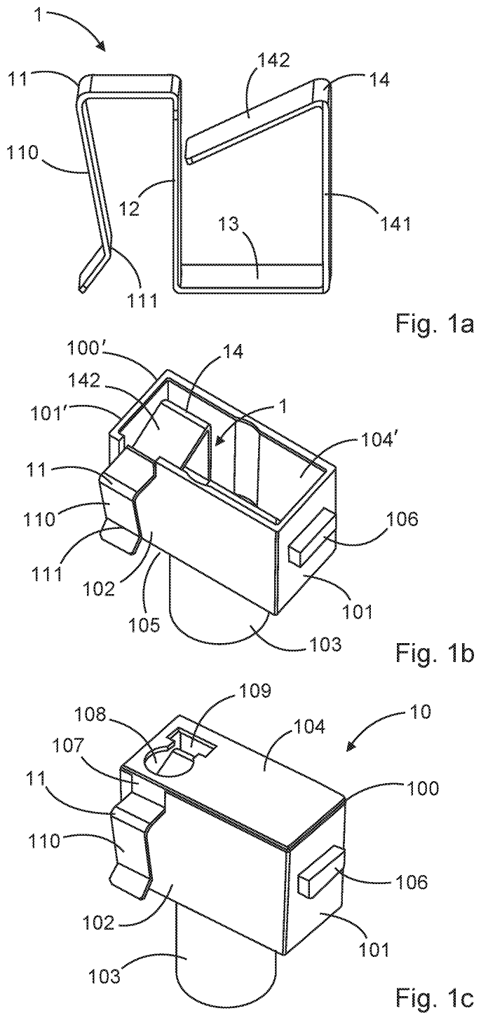

FIG. 1a shows a grounding element;

FIG. 1b shows a base housing with the inserted grounding element;

FIG. 1c shows a grounding module with a housing and the grounding element;

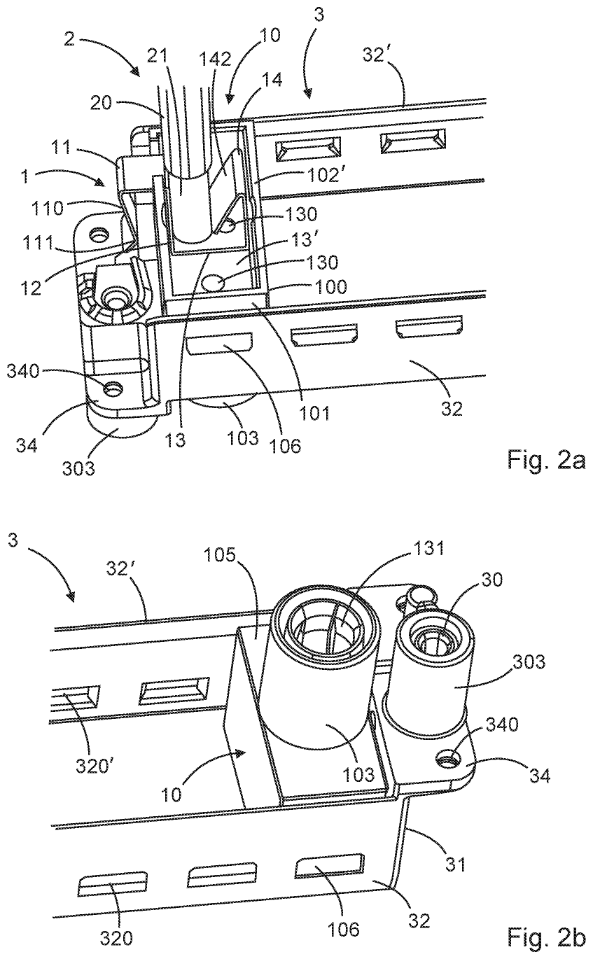

FIG. 2a shows the grounding module received in a plug connector modular frame, with an inserted grounding cable, viewed from the cable connection side;

FIG. 2b shows the grounding module received in the plug connector modular frame, viewed from the plug-in side;

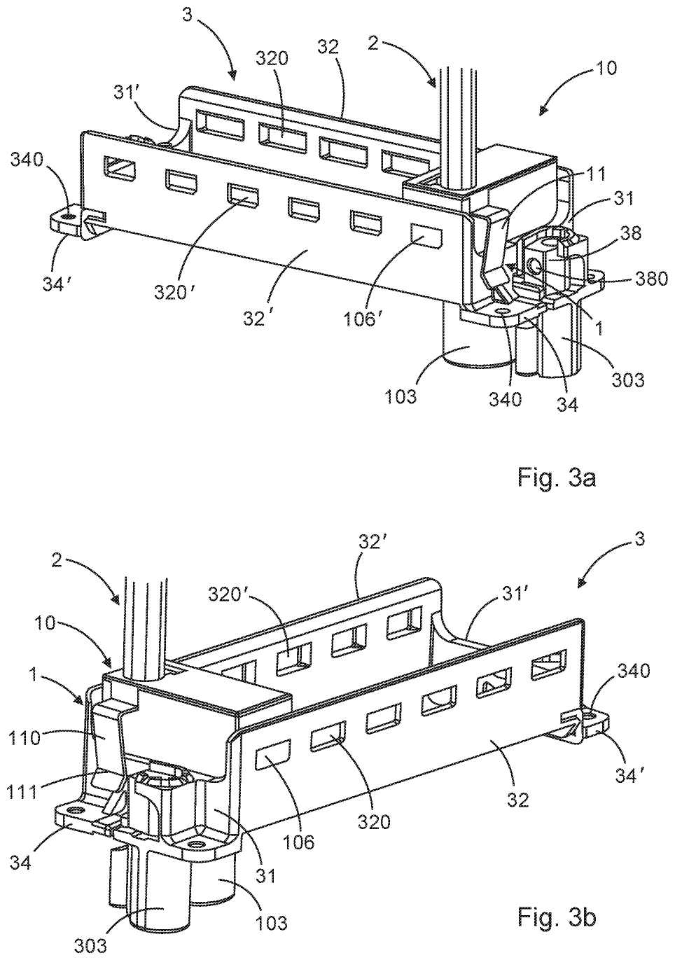

FIGS. 3a, bshow the plug connector modular frame with the inserted grounding element from two different angles of view;

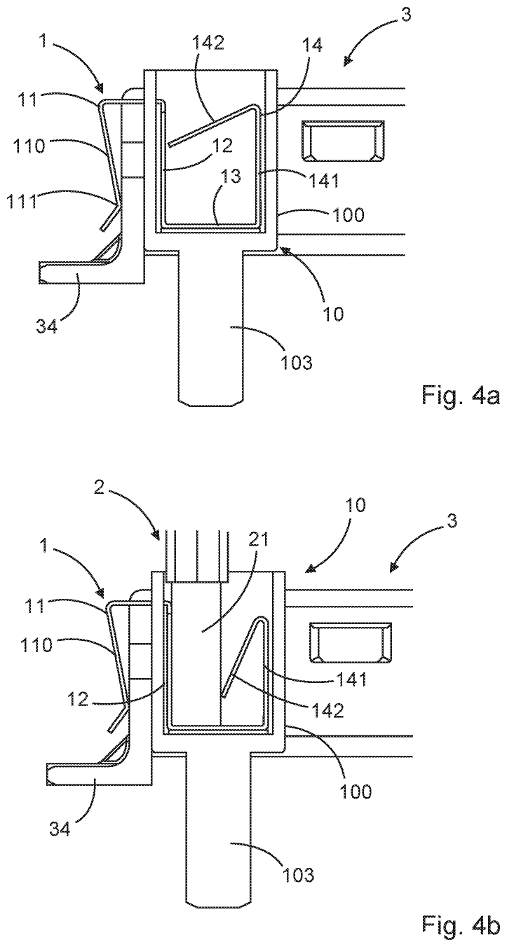

FIGS. 4a, bshow the plug connector modular frame with the inserted grounding module with and without the grounding cable, in a sectioned view.

In some cases, the figures contain simplified schematic illustrations. In some cases, identical reference signs are used for elements that are the same but may not be identical. Different views of the same elements may be on a different scale. Direction indicators such as “left”, “right”, “top” and “bottom” should be understood with reference to the respective figure and may vary in relation to the object illustrated in the individual illustrations.

FIG. 1a shows a grounding element 1. At least in some region or regions, this has elastic and electrically conductive properties. In the embodiment under consideration, it consists completely of spring-elastic sheet metal and is embodied as a one-piece stamped and bent part. To produce it, an elongate, in particular rectangular, basic shape is first stamped out from a sheet. This basic shape has a length along the longitudinal axis which is significantly greater than its width. The length of this basic shape is more than five times, in particular more than eight times, preferably more than ten times, and particularly preferably more than twelve times, as great as its width.

To form the grounding element 1, the stamped and bent part is bent at a number of bending edges running perpendicularly to the longitudinal axis.

Moreover, the grounding element 1 is even bent at right angles at some of these bending edges. In the exemplary embodiment shown in the drawing, various portions 11, 12, 13, 14 of the grounding element 1 are separated from one another by the right-angled bending edges. It is of course clear here to a person skilled in the art that separation of various portions would also be possible by means of bending edges with bending angles that are not right-angled.

First of all, the grounding element 1 has a contact spring 11, illustrated on the left in the drawing, for establishing electrical contact with a metal plug connector modular frame 3 (shown for the first time in FIG. 2b). This contact spring 11 has a substantially S-shaped profile, by means of which a contact arm 110 with a contact edge or at least one contact region 111 is formed.

Adjoining this S-shaped contact spring 11 at the first right-angled bend is a busbar 12, which runs vertically in the drawing and therefore is bent away at a right angle from the abovementioned S-shaped contact spring 11. This busbar 12 is provided for electrically conductive connection to a grounding line 21 (shown for the first time in FIG. 2a).

A further, central, portion, which once again runs horizontally in the drawing, is bent away as a connecting portion 13 from this busbar 12. On the one hand, this connecting portion 13 serves to establish a connection with the retention leg 141 of a clamping spring 14, said retention leg, for its part, being bent away from the connecting portion 13. On the other hand, however, a plug-in contact 131 (not shown here) can also be connected in an electrically conductive manner to the connecting portion 13 and optionally also secured thereon.

As already indicated, said retention leg 141 of the V-shaped clamping spring 14, which retention leg runs vertically in the drawing, adjoins the connecting portion 13, being illustrated on the right and pointing upward in the drawing. This retention leg 141 is thus parallel and opposite to the abovementioned busbar 12. In addition, the V-shaped clamping spring 14 has, adjoining the retention leg 141, a clamping leg 142, which is bent away at an acute angle from said retention leg and, at its free end, can be pivoted elastically in order to press a grounding line 21 (illustrated for the first time in FIG. 2a) which has been inserted (from above in the drawing) against said busbar 12 with the required restoring force and thus to connect it thereto in an electrically conductive manner and, at the same time, to clamp/wedge the grounding line 21 against being pulled out accidentally counter to the insertion direction.

To summarize the explanation, FIG. 1a shows a grounding element 1 which, although it has a plurality of functionally very different portions 11, 12, 13, 14, is of one-piece design and can thus be produced with very little effort. In the example under consideration, it can be produced as a stamped and bent part and, in particular, can consist of spring-elastic sheet metal. Thus, the grounding element 1 can be produced with only a little effort. For this purpose, it can be stamped out of a spring-elastic sheet in an elongate rectangular shape, for example, and bent, in particular at right angles, at several points. This gives rise, inter alia, to the formation of the abovementioned portions 11, 12, 13, 14, as a result of which the one-piece grounding element 1 unites in itself the large variety of very different functions, as described above.

FIG. 1b shows a base housing 100′ of a grounding module 10 when viewed in the direction of the cable connection side 104′, which is open in this illustration. The base housing 100′ is of substantially cuboidal design and has two mutually parallel narrow sides 101, 101′, namely a first narrow side 101 and a second narrow side 101′. In addition, the base housing 100′ has two broad sides 102, 102′ running at right angles to the narrow sides 101, 101′, namely a first broad side 102 and a second broad side 102′, which connect the two narrow sides 101, 101′ to one another. The narrow sides 101, 101′ and the broad sides 102, 102′ are outer sides. On each of its narrow sides 101, 101′, the base housing 100′ has a latching projection 106, 106′, of which only one latching projection 106 can be seen in this illustration. Moreover, the base housing 100′ has a hollow-cylindrical contact molding 103 for the reception of a plug-in contact 131 (shown in FIG. 2b), which is connected to the grounding element 1 in an electrically conductive manner.

FIG. 1c shows a grounding module 10, where, in contrast to the previous illustration, a top-mounted part 104 in the form of a cover is mounted on the base housing 100′ and secured thereon on the cable connection side. Together with the top-mounted part 104, the base housing 100′ thus forms the housing 100 of the grounding module 10. The top-mounted part 104 has a cable insertion opening 108 and an actuation opening 109.

Thus, the grounding module 10 has said cable connection side 104′, on which the top-mounted part 104 is arranged, and a plug-in side 105 (facing away from the direction of view in the drawing), wherein the cable connection side 104′ and the top-mounted part 104, on the one hand, and the plug-in side 105, on the other hand, are arranged opposite one another and at right angles to the narrow sides 101, 101′ and broad sides 102, 102′.

The grounding element 1 is arranged partially inside and partially outside the housing 100. More specifically, as is evident also from the previous illustrations, the busbar 12, the connecting portion 13 and the V-shaped clamping spring 14 of the grounding element 1 are arranged inside the base housing 100′, but, at the same time, as can be seen in FIG. 1c, the contact spring 11 of said grounding element projects out of the housing 100 through an aperture 107. This aperture 107 is arranged on or at least in the vicinity of the cable connection side 104′/of the top-mounted part 104 of the grounding module 10. The contact arm 110 of the substantially S-shaped contact spring 11 projecting through the aperture 107 extends along the first broad side 102 of the housing 100 from the direction of the cable connection side 104′ in the direction of the plug-in side 105, i.e. from the top down in the drawing.

FIG. 2a shows a plug connector modular frame 3 with a grounding module 10 received therein and an electrical grounding cable 2 connected thereto from the direction of the cable connection side, wherein to illustrate the connection method, the top-mounted part 104 of the grounding module 10 is omitted, with the result that the base housing 100′ is the only part of the housing 100 of the grounding module 10 which can be seen.

The grounding cable 2 has a grounding line 21 and insulation, which surrounds the grounding line 21 and, for example, is green/yellow-striped to distinguish it by the use of color. The grounding cable 2 is inserted by means of its grounding line 21, which is insulated at the end, into the grounding module 10 from above in the drawing, wherein the grounding line 21 gets between the busbar 12 and the clamping leg 142. During this process, the clamping leg 142 is deflected elastically in the direction of the retention leg 141 and presses the grounding line 21 against the busbar 12 by means of a restoring force which arises as a result. As a result, the grounding line 21 is connected to the busbar 12 over a large area and thus in an electrically conductive manner with a high electrical conductance. At the same time, the grounding cable 2 is secured against being accidentally pulled out counter to the insertion direction since the clamping leg 142 digs into the grounding conductor 21 over a certain area during the attempt to remove the grounding cable 2 counter to the plug-in direction (i.e. upward in the drawing), and thus locks against this movement. During this process, the retention leg 141 of the clamping spring 14 is supported against a broad side 102 of the housing 100.

At the same time, the contact spring 11 contacts the plug connector modular frame 3 by means of its contact arm 110, to be more precise by means of the contact region 111 of the contact arm 110. Thus, the grounding element 1 establishes an electrically conductive connection between the metal plug connector modular frame 3 and the grounding line 21.

In the embodiment shown here, a through opening is made in the connecting portion 13 as a fastening opening 130. The plug-in contact 131 shown in the following illustration can be attached, e.g. riveted or screwed, by means of its connection region to this fastening opening 130 and thereby also connected in an electrically conductive manner to the grounding element 1, wherein this plug-in contact 131 then serves for grounding transmission to a mating plug.

However, if the plug-in contact 131 cannot be attached to the fastening opening 130 for reasons of space because it is arranged offset with respect to the latter, it is additionally possible, in another embodiment, which is herewith expressly disclosed in connection with the invention, for a further connecting part 13′ to be inserted into the housing 100. This further connecting part 13′ consists of metal, is flat, in particular of rectangular design, and has two further fastening openings 130′, of which only one can be seen here because the other is directly below the fastening opening 130 in the grounding element 1, in order to connect the connecting part 13′ mechanically and in an electrically conductive manner to the connecting portion 13′. The plug-in contact 131 can then be attached to the further fastening opening 130′, which is visible here.

In another embodiment, which is herewith likewise expressly disclosed as belonging to the invention but which is not shown in the drawing, the connecting part 13′ can be embodied in such a way that it has the same effect functionally but is integral with the grounding element 1, e.g. by making the connecting portion 13 of the grounding element 1 wider than the other portions 11, 12, 14. By this means too, it is possible to compensate for such an offset by likewise arranging the fastening opening 130 offset with respect to the busbar 12.

In each of the abovementioned cases, this through opening 130 is provided as a fastening opening 130 for the plug-in contact 131.

FIG. 2b shows the arrangement from the direction of the plug-in side. This shows particularly clearly the plug-in contact 131, which, at least on the plug-in side, is situated in the contact molding 103 and, on the connection side, is connected in an electrically conductive manner to the connecting portion 13 of the grounding element 1.

As is particularly clearly visible in FIGS. 3a and 3b, the plug connector modular frame 3 has a rectangular basic shape with two end faces 31, 31′ and two side parts 32, 32′. Arranged in the two side parts 32, 32′ of the plug connector modular frame 3 are recesses 320, 320′ of different sizes, in which the latching projections 106, 106′ of the grounding module 10 received in the plug connector modular frame 3 are arranged.

In this case, not only the recesses 320, 320′ in both side parts 32, 32′ of the plug connector modular frame 3 but also the latching projections 106, 106′ of the grounding module 10 are of different sizes. The orientation of the grounding module 10 in the plug connector modular frame 3 is thereby also fixed. The same applies to additional, identical or different, plug connector modules (not shown) which can be received in the plug connector modular frames 3 and the housings of which are comparable.

Formed integrally on each of the end faces 31, 31′ of the plug connector modular frame 3 is a flange 34, 34′ projecting at right angles therefrom. Each of these two flanges 34, 34′ has two screw holes 340 for screwing into or onto a plug connector housing or onto a wall aperture in a housing wall for mutual fastening and electrical grounding connection.

One of the two flanges 34 has a PG screw contact 38. This screw contact has a connection opening 380, a grounding contact molding 303 and a grounding contact 30. However, as can clearly be seen in FIG. 2d, the plug-in contact 131 of the grounding module 10 is significantly larger than the grounding contact 30 of the plug connector modular frame 3. Moreover, it also becomes clear from the illustration in FIG. 3a that the conductor cross section of the grounding cable 2 is significantly greater than a possible conductor cross section of a further grounding cable which fits into the connection opening 380 of the PG screw contact 38.

The grounding module 10 thus makes possible an additional, significantly enlarged grounding cross section for grounding the plug connector modular frame 3. This is particularly relevant for plug connector modular systems which are capable of transferring particularly high currents, e.g. more than 32 A or even more than 64 A or even more than 90 or even more than 96 A.

Finally, FIGS. 4a and 4b illustrate the arrangement already shown above with and without the inserted grounding cable 2 in a cross-sectional illustration. As was already evident in FIG. 3a, the grounding cable 2 is inserted into the grounding module 10 through the cable insertion opening 108 shown in FIG. 1c. In the example under consideration, the rectangular actuation opening 109 is connected to this round cable insertion opening 108, but could also be arranged separately from it.

This actuation opening 109 serves to enable the grounding line 21 also to be released again from the grounding element 1. For this purpose, it is namely possible, with the grounding cable 2 inserted, that is to say, for example, in FIG. 4b, for a screwdriver or a similarly acting tool to be inserted into the grounding module 10 from above in the drawing and pressed onto the clamping leg 142. As a result, the clamping leg 142 releases the grounding line 21 again, and the grounding cable 2 can be removed counter to its insertion direction. During this process, the clamping spring 14 is supported from the inside on the housing 100 by means of its retention leg 141.

If the grounding line 21 is a particularly flexible stranded conductor, which is therefore not stiff enough to pivot the clamping leg 142 sufficiently by its own strength and which is also not provided with an end sleeve, the clamping leg 142 can alternatively also be deflected by means of the screwdriver inserted through the actuation opening 109 to enable this stranded conductor to be inserted without mechanical resistance. Although this does not correspond entirely to the convenience of operation desired, it does at least make it possible to electrically connect even very thin stranded conductors without end sleeves to the grounding element 1 when required.

### LIST OF REFERENCE SIGNS

1 grounding element
11 contact spring
110 contact arm
111 contact region/contact edge
12 busbar
13 connecting portion (central portion)
130 fastening opening
13′ connecting part
130′ further fastening opening
131 plug-in contact
14 clamping spring
141 retention leg
142 clamping leg
10 grounding module
100 housing
100′ base housing (without top-mounted part)
101, 101′ narrow sides
102, 102′ broad sides
103 contact molding
104 top-mounted part
104′ cable connection side
105 plug-in side
106 latching projection
107 aperture
108 cable insertion opening
109 actuation opening
2 grounding cable
20 insulation
21 grounding line
3 plug connector modular frame
31 end faces
32 side parts
320, 320′ recesses/latching windows
30 grounding contact
303 grounding contact molding
34 flange
340 screw openings/screw holes
38 PG screw contact
380 connection opening

1. A grounding module which is to be received in a metal plug connector modular frame and which grounds the same by electrically conductive connection of the plug connector modular frame to a grounding line, wherein the grounding module comprises:
a housing, which has one or more fixing devices for fixing the grounding module in the plug connector modular frame; and
a busbar, arranged in the housing, for the mechanical and electrical contacting of said grounding line;
a clamping spring arranged at least partially in the housing and having a clamping leg for pressing and clamping the grounding line inserted or to be inserted against the busbar; and
a contact spring, which is connected in an electrically conductive manner to the busbar and is passed out of the housing to an outer side of the housing in order to contact the metal plug connector modular frame in an electrically conductive manner, wherein both the busbar and the clamping spring and the contact spring are jointly part of a single, one-piece grounding element.

2. The grounding module as claimed in claim 1, wherein the grounding clement consists of spring-elastic sheet metal.

3. The grounding module as claimed in claim 1, wherein the grounding element is a stamped and bent part.

4. The grounding module as claimed in claim 1, wherein the housing has a cuboidal basic shape with at least four outer sides, including two narrow sides,which run parallel to one another, and two broad sides, which run at right angles to the narrow sides and connect the narrow sides to one another.

5. The grounding module as claimed in claim 4, wherein the housing has two further outer sides, including a cable connection side and a plug-in side, which are arranged opposite one another at right angles to the narrow sides and the broad side.

6. The grounding module as claimed in claim 4, wherein said one or more fixing meansdevices are two latching projections, each of which is formed integrally on one of the two narrow sides of the housing.

7. The grounding module as claimed in claim 6, wherein the two latching projections differ from one another in size and/or shape in order to ensure the correct polarization of the grounding module in the plug connector modular frame.

8. The grounding module as claimed in claim 4, wherein the contact spring extends along the first broad side of the housing, coming from the direction of the cable connection side and running in an S shape in the direction of the plug-in side, with the result that the distance between the contact spring and the first broad side varies, in order to establish electrical contact externally between the plug connector modular frame and a contact region of the spring arm when the grounding module is inserted into said frame.

9. The grounding module as claimed in claim 4, wherein the housing has, on its cable connection side, a top-mounted part, which has a cable insertion opening for the insertion of the grounding line.

10. The grounding module as claimed in claim 9. wherein the top-mounted part additionally has an actuation opening for the insertion of a tool for separating the clamping leg from the grounding line and thus for releasing the grounding line from the busbar.

11. The grounding module as claimed in claim 1, wherein the grounding module additionally has a plug-in contactm which is connected in an electrically conductive manner to the busbar.

12. The grounding module as claimed in claim 11, wherein the clamping spring is connected in an electrically conductive manner to the busbar via a connecting portion, wherein the connecting portion has a through opening as a fastening openingfor the plug-in contact.

13. The grounding module as claimed in claim 1, wherein the housing consists at least partially of plastic.

14. The grounding module as claimed in claim 1, wherein the housing consists at least partially of metal.

15. gA plug connector modular system, having at least the grounding module as claimed in claim 1 and a plug connector modular frame, wherein the plug connector modular frame is of substantially rectangular design in cross section, having, two end faces situated opposite and parallel to one another and, at right angles thereto, two side parts situated opposite and parallel to one another, wherein a flange is formed integrally on the end faces, in each case projecting at right angles thereto, wherein each of these two flanges has two through openings as screw openings, with the result that the plug connector modular frame has a total of four screw openings, at which it can be screwed into or onto a metal plug connector housing for the purpose of fastening and establishing electrical contact, wherein the grounding module is received or at least can be received in the plug connector modular frame and, o establishes electrical contact with this plug connector modular frame using its contact spring in the received state, whereinthe grounding module is configured to press the grounding line against the busbar using its clamping spring in order in this way to establish an electrically conductive connection between the grounding line and the metal plug connector housing.

16. The plug connector modular system as claimed in claim 15, wherein the plug connector modular system has one or more identical and/or different additional plug connector modules, which are received or at least can be received in the plug connector modular frame.

17. The grounding module as claimed in claim 5, wherein said one or more fixing devices are two latching projections, each of which is formed integrally on one of the two narrow sides of the housing.

18. The grounding module as claimed in claim 17, wherein the two latching projections differ from one another in size and/or shape in order to ensure the correct polarization of the grounding module in the plug connector modular frame.

19. The grounding module as claimed in claim 5, wherein the contact spring extends along the first broad side of the housing, coming from the direction of the cable connection side and running in an S shape in the direction of the plug-in side, with the result that the distance between the contact spring and the first broad side varies, in order to establish electrical contact externally between the plug connector modular frame and a contact region of the spring arm when the grounding module is inserted into said frame.

20. The grounding module as claimed in claim 5, wherein the housing has, on its cable connection side, a top-mounted part, which has a cable insertion opening for the insertion of the grounding line.
